(19) United States
(12) Patent Application Publication
(10) Pub. No.: US 2013/0214190 A1
(43) Pub. Date: Aug. 22, 2013

(54) AIR VALVE AND METHOD FOR REFURBISHING AN AIR VALVE

(71) Applicants: Cole Frantz Semones, Salem, VA (US); Kenneth Andrew Hodges, Salem, VA (US)

(72) Inventors: Cole Frantz Semones, Salem, VA (US); Kenneth Andrew Hodges, Salem, VA (US)

(73) Assignee: Graham-White Manufacturing Company, Salem, VA (US)

(21) Appl. No.: 13/402,113

(22) Filed: Feb. 22, 2012

(51) Int. Cl. F16K 1/00; B23P 6/00

(52) U.S. Cl. 251/324; 29/402.19

(57) ABSTRACT

An air valve includes a valve body and a disc configured to engage a seat. An inlet port is upstream from the seat, and an outlet port is downstream from the seat. A stern is connected to the disc, and a piston is connected to the stern, wherein the piston has first and second positions. A chamber is defined at least in part by the piston and the valve body. A clearance between the valve body and the stem has a first cross-sectional area. One or more relief ports provide fluid communication from the chamber through the valve body and have a combined second cross-sectional area that is greater than or equal to the first cross-sectional area. A method for refurbishing the air valve, as previously described, includes increasing the second cross-sectional area greater than or equal to the first cross-sectional area.

### FIELD OF THE INVENTION

The present invention generally involves an air valve and a method for refurbishing an air valve. In particular embodiments, the air valve may be incorporated into a horn or other pneumatic system on a locomotive.

### BACKGROUND OF THE INVENTION

Pneumatic systems commonly include air valves to isolate and/or regulate fluid flow. For example, locomotives typically include one or more pneumatic systems that supply air to the brakes, horn, and other auxiliary systems. In the case of a horn, an air valve may alternately permit or prevent air flow through the horn to provide a readily audible signal of an approaching locomotive. In many cases, the pressure and/or volume of the air flow through the air valve may be substantial, requiring a larger air valve that may be difficult to operate. As a result, a smaller pilot valve may be used to operate the larger air valve. The pilot valve may include, for example, a smaller air valve and/or a solenoid valve operably connected to the larger air valve.

Over time, the high pressure and high flow rates of the air through the air valve may erode various seals and/or seating surfaces in the air valve. As the seals and/or seating surfaces erode, the high pressure air may leak inside the air valve, affecting operation of the air valve. For example, internal leaks in the air valve may lead to reduced reliability of the air valve and associated systems. In the case of the horn operated by high pressure air, reduced reliability in the horn directly affects the safe operation of the locomotive and can lead to increased health and safety issues and/or reduced operational availability of the locomotive. Therefore, an improved air valve and method for refurbishing an air valve that accommodates internal leaks in the air valve would be useful.

### BRIEF DESCRIPTION OF THE INVENTION

Aspects and advantages of the invention are set forth below in the following description, or may be obvious from the description, or may be learned through practice of the invention.

One embodiment of the present invention is an air valve that includes a valve body and a first disc configured to engage a first seat inside the valve body. An inlet port is upstream from the first seat, and a first outlet port is downstream from the first seat. A stem is connected to the first disc, and a piston is connected to the stem, wherein the piston has a first position in which the first disc is engaged with the first seat and a second position in which the first disc is separated from the first seat. A chamber is defined at least in part by the piston and the valve body. A clearance between the valve body and the stein has a first cross-sectional area, and the clearance provides a fluid pathway from the inlet port to the chamber. One or more relief ports provide fluid communication from the chamber through the valve body and have a combined second cross-sectional area that is greater than or equal to the first cross-sectional area.

Another embodiment of the present invention is an air valve that includes a valve body, a first disc configured to engage a first seat inside the valve body, and a second disc configured to engage a second seat inside the valve body. An inlet port is upstream from the first seat, and a first outlet port is downstream from the first seat and upstream from the second seat. A stem connects the first disc to the second disc, and a piston is connected to the stern, wherein the piston has a first position in which the first disc is engaged with the first seat and a second position in which the second disc is engaged with the second seat. A chamber is defined at least in part by the piston and the valve body. A clearance between the valve body and the second disc has a first cross-sectional area, and the clearance provides a fluid pathway from the inlet port to the chamber. One or more relief ports provide fluid communication from the chamber through the valve body and have a combined second cross-sectional area that is greater than or equal to the first cross-sectional area.

The present invention may also include a method for refurbishing an air valve, as previously described, by increasing the second cross-sectional area greater than or equal to the first cross-sectional area.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a side cross-section view of an exemplary air valve in a shut position;

FIG. 2 is a side cross-section view of the air valve shown in FIG. 1 in an open position;

FIG. 3 is an axial cross-section view of the exemplary air valve shown in FIG. 1 taken along line 3-3;

FIG. 4 is a side cross-section view of the air valve shown in FIG. 1 in an intermediate position;

FIG. 5 is a side cross-section view of an air valve according to a first embodiment of the present invention; and

FIG. 6 is a side cross-section view of an air valve according to a second embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include an air valve and method for refurbishing an air valve. The air valve generally includes a valve body and one or more discs and seats configured to alternately prevent or permit air flow through the valve. The air valve may include a stern that connects a piston to one or more of the discs so that movement of the piston controls the position of the one or more discs with respect to the seats to open or shut the air valve. The piston and valve body may at least partially define a chamber, and in particular embodiments, a clearance between the valve body and the stem or one of the discs may provide a fluid pathway into the chamber. A seal between the stern and the valve body may reduce or prevent fluid flow into the chamber, and one or more relief ports through the chamber may prevent the accumulation or buildup of pressure inside the chamber that may interfere with the reliable operation of the air valve. Although exemplary embodiments of the present invention may be described in the context of a locomotive horn, one of ordinary skill in the art will readily appreciate other uses for the various embodiments, and the present invention is not limited to any particular use unless specifically recited in the claims.

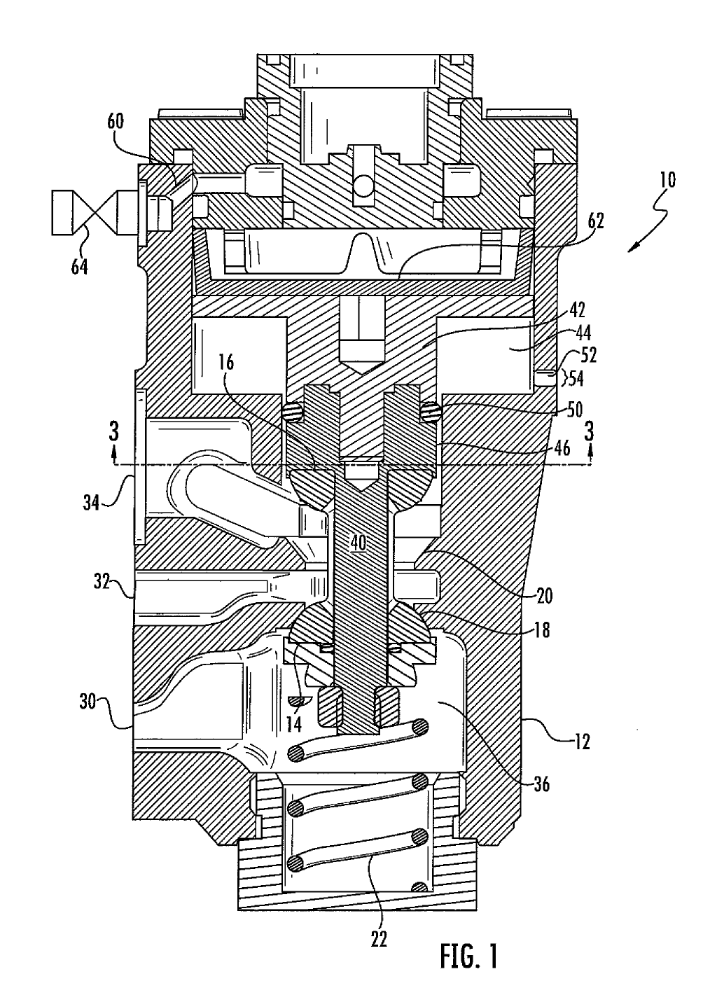

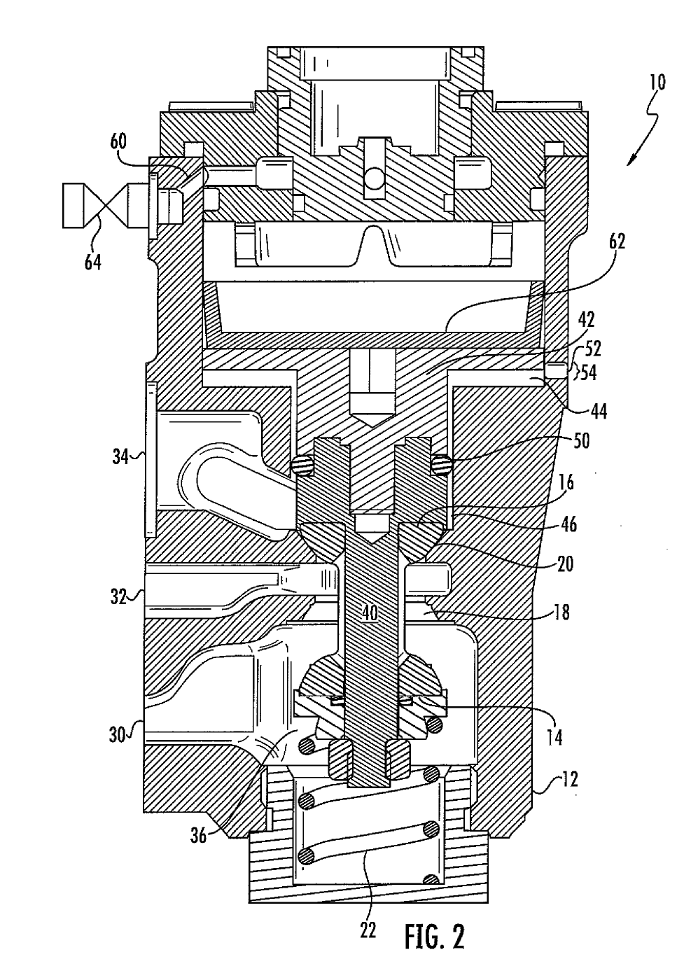

FIGS. 1 and 2 provide side cross-section views of an exemplary air valve 10 in various positions. As shown, the exemplary air valve 10 generally includes a valve body 12 and first and second discs 14, 16 configured to engage with first and second seats 18, 20, respectively, inside the valve body 12. The discs 14, 16 and seats 18, 20 generally have complementary surfaces that prevent fluid flow through the seats 18, 20 when engaged with the respective discs 14, 16. For example, as shown in FIG. 1, the first disc 14 may be engaged with the first seat 18 to prevent fluid flow through the first seat 18, while the second disc 16 may be separated from the second seat 20 to permit fluid flow through the second seat 20. Conversely, as shown in FIG. 2, the first disc 14 may be separated from the first seat 18 to permit fluid flow through the first seat 18, while the second disc 16 may be engaged with the second seat 20 to prevent fluid flow through the second seat 20. Either or both of the first and/or second discs 14, 16 may be biased in a particular position. For example, as shown in FIGS. 1 and 2, a spring 22 may be connected to the first disc 14 to bias the first disc 14 toward or away from the first seat 18.

The exemplary air valve 10 may include various ports that provide fluid communication to and from the air valve 10. For example, as shown in FIGS. 1 and 2, the exemplary air valve 10 may include an inlet port 30, a first outlet port 32, and/or a second outlet port 34. The inlet port 30 may be located upstream from the first seat 18 to provide fluid communication from a pressurized air supply (not shown) to an inlet plenum 36 upstream from the first seat 18. The first outlet port 32 may be located downstream from the first seat 18 and upstream from the second seat 20 to provide fluid communication from the air valve 10 to a downstream component, such as a horn or other pneumatic device. Lastly, the second outlet port 34 may be located downstream from the second seat 20 to provide fluid communication out of the air valve 10 to vent any pressure or air flow that may accumulate as a result of leakage past the first disc 14 and first seat 18.

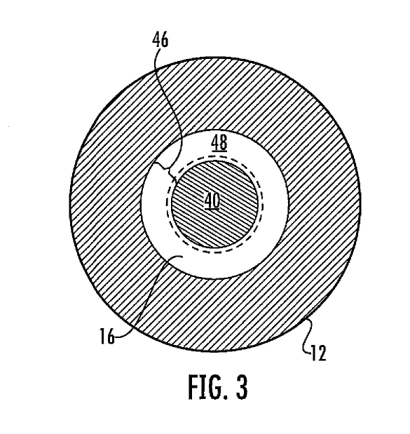

The exemplary air valve 10 may also include a stem 40 that connects the first and/or second discs 14, 16 to a piston 42, and the piston 42 and the valve body 12 may at least in part define a chamber 44 inside the valve body 12. FIG. 3 provides an axial cross-section of the exemplary air valve 10 shown in FIG. 1 taken along line 3-3. As shown in FIG. 3, a clearance 46 between the valve body 12 and the stern 40 and/or the valve body 12 and the second disc 16 may have a cross-sectional area 48. The clearance 46 may be the result of design tolerances associated with manufacturing and/or assembling the second disc 16 and stern 40 inside the valve body 12 and generally provides a fluid pathway from the inlet port 30 to the chamber 44 when the first and second discs 14, 16 are separated from their respective seats 18, 20. In addition, normal wear associated with operation of the exemplary air valve 10 may change the clearance 46, generally increasing the clearance 46 and cross-sectional area 48 over the life of the exemplary air valve 10. As a result, the exemplary air valve 10 may further include a seal 50 between the stem 40 and the valve body 12 downstream from the second seat 20 to reduce or prevent fluid flow into the chamber 44. The seal 50 may include, for example, a washer, wiper, gasket, or other suitable material installed between the stem 40 and the valve body 12 to reduce or prevent fluid flow through the clearance 46.

Returning to FIGS. 1 and 2, the fluid that flows through the clearance 46 and past the seal 50 may collect in the chamber 44 formed by the piston 42 and the valve body 12. As a result, the chamber 44 may include one or more relief ports 52 that provide fluid communication from the chamber 44 through the valve body 12 to vent fluid flow out of the chamber 44. The relief ports 52 have a combined cross-sectional area 54 that determines the flow rate out of the chamber 44.

A pilot valve, solenoid, or other suitable device may be operably connected to the piston 42 to actuate the piston 42 and thereby reposition the first and/or second discs 14, 16. For example, as shown in FIGS. 1 and 2, a pilot air port 60 may be operably connected to the piston 42 to alternately prevent or provide pilot air to an upper surface 62 of the piston 42. As shown in FIG. 1, a valve 64 may be shut to isolate pilot air from the pilot air port 60. As a result, the spring 22 connected to the first disc 14 will bias the first disc 14, second disc 16, stem 40, and piston 42 to a first position in which the first disc 14 is engaged with the first seat 18 and the second disc 16 is separated from the second seat 20. In this first position, the engagement between the first disc 14 and the first seat 18 prevents fluid flow from the inlet port 30 from flowing through the first seal 18, resulting in the exemplary air valve 10 being shut. As shown in FIG. 2, the valve 64 may be opened to provide pilot air to the pilot air port 60. As a result, the force on the upper surface 62 of the piston 42 will overcome force of the spring 22, moving the first disc 14, second disc 16, stem 40, and piston 42 to a second position in which the first disc 14 is separated from the first seat 18 and the second disc 16 is engaged with the second seat 20. In this second position, the separation between the first disc 14 and the first seat 18 allows fluid flow from the inlet port 30, through the first seat 18, and out of the first outlet port 32, allowing the fluid flow to operate a horn, for example. In addition, the engagement between the second disc 16 and the second seat 20 prevents the fluid flow from the inlet port 30 from flowing through the second seal 18 and out of the second outlet port 34, resulting in the exemplary air valve 10 being open.

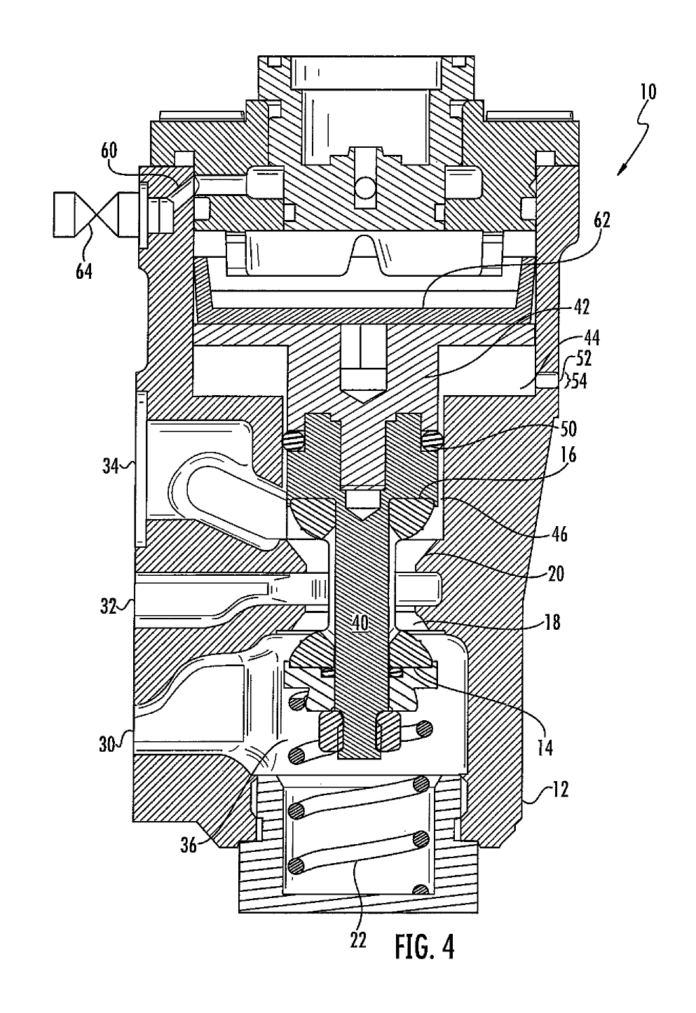

As the first disc 14, second disc 16, stern 40, and piston 42 shift from the first position (shown in FIG. 1) to the second position (shown in FIG. 2), the exemplary air valve 10 briefly passes through an intermediate position, as shown in FIG. 4. In this intermediate position, the first disc 14 has separated from the first seat 18, allowing fluid flow from the inlet port 30, through the first seat 18, and out of the first outlet port 32. However, the second disc 16 has not yet travelled the complete stroke to engage with the second seat 20. As a result, the fluid flow from the inlet port 30 may bypass the first outlet port 32 by flowing through the second seat 20 and out the second outlet port 34. In addition, the fluid flow through the second seat 20 may also leak through the clearance 46, past the seal 50, and into the chamber 44. Although the amount of fluid leaking through the clearance 46, past the seal 50, and into the chamber 44 may be insignificant for a new air valve with design tolerances, the amount of leakage tends to increase over the life of the air valve as the stem 40 and/or second disc 20 wear against the valve body 12 and/or the seal 50 degrades. If the flow rate of fluid leaking through the clearance 46, past the seal 50, and into the chamber 44 exceeds the flow rate of the fluid through the relief ports 52, then the pressure in the chamber 44 may increase sufficiently to offset the pressure being applied by the pilot air on the upper surface 62 of the piston 42. As a result, the pressure increase in the chamber 44 may prevent the piston 42, stem 40, and second disc 16 from reaching the second position, leaving the exemplary air valve 10 in the intermediate position shown in FIG. 4. In this intermediate position, the fluid flow through the first outlet port 32 may be insufficient to properly operate the horn or other component downstream from the exemplary air valve 10.

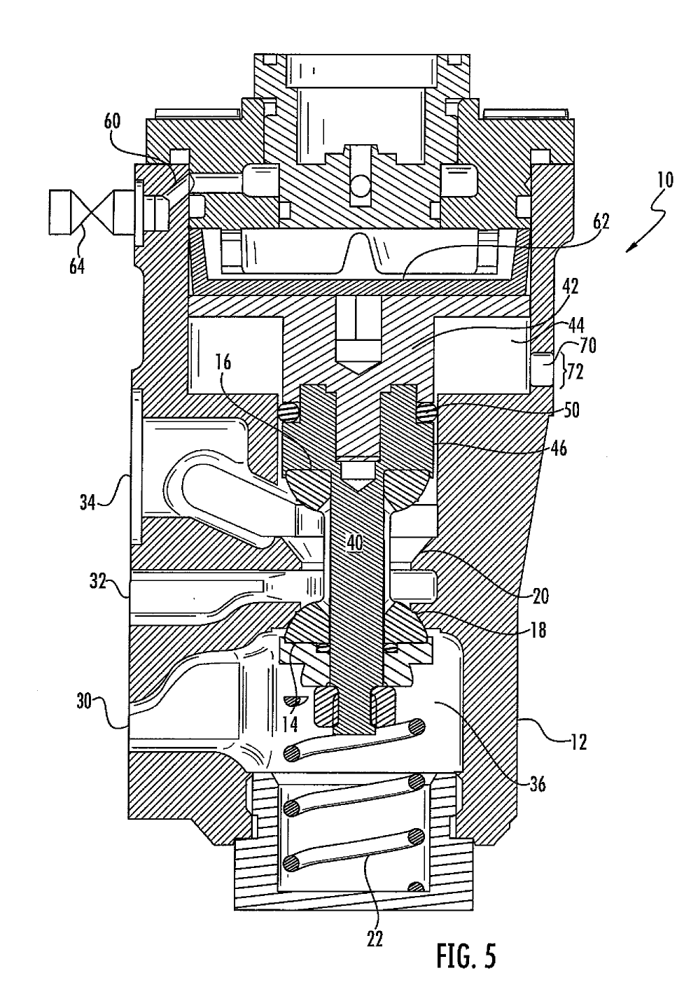

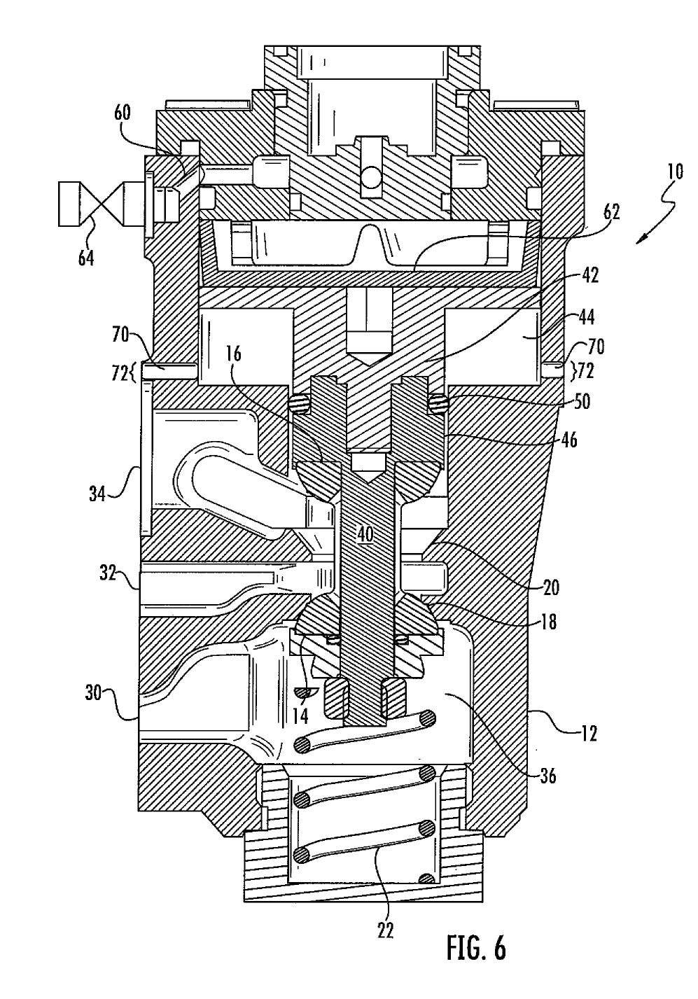

FIGS. 5 and 6 provide side cross-section views of the exemplary air valve 10 shown in FIGS. 1-3 modified according to various embodiments of the present invention. Although one of ordinary skill in the art will readily appreciate from the teachings herein that embodiments of the present invention may be applicable to. multiple different air valve designs, the principles of operation associated with various embodiments of the present invention will be illustrated in the context of the exemplary air valve 10 previously described and illustrated. As shown in FIGS. 5 and 6, the various embodiments of the present invention include one or more relief ports 70 that have a combined second cross-sectional area 72 that is greater than or equal to the cross-sectional area between the valve body 12 and the stem 40 and/or the second disc 20. Specifically, the cross-sectional area 72 of the single relief port 70 shown in FIG. 5 has been enlarged from the cross-sectional area 54 of the single relief port 52 shown in FIGS. 1, 2, and 4 so that the single relief port 70 can allow at least as much fluid flow as passes through the clearance 46. Alternately, as shown in FIG. 6, multiple relief ports 70 through the chamber 44 may have a combined cross-sectional area 72 that is greater than or equal to the cross-sectional area 48 between the valve body 12 and the stein 40 and/or the second disc 20.

The enlargement of the single relief port 70 shown in FIG. 5 or the creation of multiple relief ports 70 as shown in FIG. 6 may be readily accomplished during original manufacture of the valve body 12 and/or assembly of the air valve 10. Alternately, the size and/or number of the existing relief ports 52, shown in FIGS. 1, 2, and 4, may be readily increased during refurbishment of the air valve 10 in lieu of repeatedly repairing or replacing the seal 50. As a result, the various embodiments of the present invention may be readily incorporated into either existing valve designs during initial manufacturing and/or assembly or during periodic refurbishment of the air valve.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An air valve, comprising:
a. a valve body;
b. a first disc configured to engage a first seat inside the valve body;
c. an inlet port upstream from the first seat;
d. a first outlet port downstream from the first seat;
e. a stern connected to the first disc;
f. a piston connected to the stern, wherein the piston has a first position in which the first disc is engaged with the first seat and a second position in which the first disc is separated from the first seat;
g. a chamber defined at least in part by the piston and the valve body;
h. a clearance between the valve body and the stem, wherein the clearance has a first cross-sectional area and the clearance provides a fluid pathway from the inlet port to the chamber; and
i. one or more relief ports that provide fluid communication from the chamber through the valve body, wherein the one or more relief ports have a combined second cross-sectional area that is greater than or equal to the first cross-sectional area.

2. The air valve as in claim 1, further comprising a second disc configured to engage a second seat inside the valve body.

3. The air valve as in claim 2, further comprising a seal between the stern and the valve body downstream from the second disc, wherein the seal prevents fluid flow into the chamber.

4. The air valve as in claim 2, further comprising a second outlet port downstream from the second seat.

5. The air valve as in claim 2, wherein the stem connects the first disc to the second disc.

6. The air valve as in claim 2, wherein the second disc is separated from the second seat when the piston is in the first position.

7. The air valve as in claim 2, wherein the second disc is engaged with the second seat when the piston is in the second position.

8. The air valve as in claim 1, wherein the first disc is biased against the first seat.

9. The air valve as in claim 1, wherein the one or more relief ports comprise a plurality of fluid passages that provide fluid communication from the chamber through the valve body.

10. An air valve, comprising:
a. a valve body;
b. a first disc configured to engage a first seat inside the valve body;
c. a second disc configured to engage a second seat inside the valve body;
d. an inlet port upstream from the first seat;
e. a first outlet port downstream from the first seat and upstream from the second seat;
f. a stern that connects the first disc to the second disc;
g. a piston connected to the stem, wherein the piston has a first position in which the first disc is engaged with the first seat and a second position in which the second disc is engaged with the second seat;
h. a chamber defined at least in part by the piston and the valve body;
i. a clearance between the valve body and the second disc, wherein the clearance has a first cross-sectional area and the clearance provides a fluid pathway from the inlet port to the chamber; and
j. one or more relief ports that provide fluid communication from the chamber through the valve body, wherein the one or more relief ports have a combined second cross-sectional area that is greater than or equal to the first cross-sectional area.

11. The air valve as in claim 10, further comprising a seal between the stern and the valve body downstream from the second disc, wherein the seal prevents fluid flow into the chamber.

12. The air valve as in claim 10, wherein the first disc is biased against the first seat.

13. The air valve as in claim 10, wherein the one or more relief ports comprise a plurality of fluid passages that provide fluid communication from the chamber through the valve body.

14. The air valve as in claim 10, further comprising a second outlet port downstream from the second seat.

15. The air valve as in claim 10, wherein the second disc is separated from the second seat when the piston is in the first position.

16. The air valve as in claim 10, wherein the first disc is separated from the first seat when the piston is in the second position.

17. A method for refurbishing an air valve having a valve body; a first disc configured to engage a first seat inside the valve body; an inlet port upstream from the first seat; a first outlet port downstream from the first seat; a stem connected to the first disc; a piston connected to the stem, wherein the piston has a first position in which the first disc is engaged with the first seat and a second position in which the first disc is separated from the first seat; a chamber defined at least in part by the piston and the valve body; a clearance between the stem and the valve body, wherein the clearance has a first cross-sectional area and the clearance provides a fluid pathway from the inlet port to the chamber; and one or more relief ports that provide fluid communication from the chamber through the valve body, wherein the one or more relief ports have a combined second cross-sectional area; the method comprising:
a. increasing the second cross-sectional area greater than or equal to the first cross-sectional area.

18. The method as in claim 17, wherein the increasing step comprises enlarging the one or more relief ports.

19. The method as in claim 17, wherein the increasing step comprises creating an additional relief port that provides fluid communication from the chamber through the valve body.

20. The method as in claim 17, further comprising repairing or replacing a seal between the stem and the valve body.
